(19) United States
(12) Patent Application Publication
(10) Pub. No.: US 2016/0133243 A1
(43) Pub. Date: May 12, 2016

(54) MUSICAL PERFORMANCE SYSTEM, MUSICAL PERFORMANCE METHOD AND MUSICAL PERFORMANCE PROGRAM

(71) Applicant: YAMAHA CORPORATION, Shizuoka (JP)

(72) Inventor: Haruki UEHARA, Hamamatsu-shi, Shizuoka (JP)

(73) Assignee: Yamaha Corporation, Hamamatsu-shi, Shizuoka (JP)

(21) Appl. No.: 14/898,588

(22) PCT Filed: Jun. 16, 2014
(86) PCT No.: PCT/JP2014/065945

§ 371 Date: Dec. 15, 2015

(30) Foreign Application Priority Data
Jun. 17, 2013 (JP) 2013-127008

(51) Int. Cl. G10H 1/00

(52) U.S. Cl. CPC G10H 1/0066; G10H 2220/455; G10H 2220/091

(57) ABSTRACT

The present invention allows a user to visually identify musical performance data to be reproduced. The user utilizes a musical performance device (100) and an image pickup device (200) that picks up an image of the musical performance to record the musical performance data onto a musical performance recording server device (400) with a musical performance date/time. Further, image data is recorded onto an image recording server device (300) with the image pickup date/time. To reproduce the musical performance, the user visually selects the image picked up from among the images recorded on the image recording server device (300). The musical performance data associated with the musical performance date/time close to the image pickup date/time of the selected image is identified on the musical performance recording server device (400), and the musical performance is reproduced on the musical performance device (100) based on the identified musical performance data.

### TECHNICAL FIELD

The present invention relates to a technology for recording information on a musical performance and reproducing the musical performance.

### BACKGROUND ART

As a device for recording musical performance data indicating details of an operation of a keyboard, there is known a musical performance recording device disclosed in Patent Literature 1. In a musical performance data recording mode, this musical performance recording device stores the musical performance data and time information that are chronologically generated based on the operation of the keyboard into a temporary storage area in pairs, and stores a musical performance recording file obtained by combining a plurality of pieces of musical performance data onto an external storage device. Meanwhile, in a musical performance data reproducing mode, this musical performance recording device retrieves the musical performance recording file corresponding to a time selected by a user, and reproduces the retrieved musical performance recording file.

### CITATION LIST

### Patent Literature

[Patent Literature 1] JP 2008-233574 A

### SUMMARY OF INVENTION

### Technical Problem

The number of recorded pieces of musical performance data may become enormous, and hence it is desired that a user can select a piece of musical performance data to be reproduced from a group of those pieces of data as easily as possible. Therefore, an object of one or more embodiments of the present invention is to enable the user to visually identify the musical performance data to be reproduced with ease.

### Solution to Problem

According to one aspect of the present invention, there is provided a musical performance recording device, including: a first storage unit configured to store musical performance data indicating a musical performance and musical performance date/time data relating to a date/time when the musical performance was given in association with each other; a second storage unit configured to store image data indicating an image and image date/time data indicating a date/time relating to pickup or recording of the image in association with each other; and a transmission unit configured to identify the image date/time data associated with a piece of image data selected by the user from among pieces of image data stored in the second storage unit, and transmit the musical performance data associated with the musical performance date/time data having a predetermined relationship with the identified image date/time data in the first storage unit to a musical performance device.

Further, according to another aspect of the present invention, there is provided a musical performance recording/reproducing system, including: an image pickup device configured to pick up an image; a musical performance device configured to give a musical performance based on musical performance data; and a musical performance recording device configured to record musical performance data indicating a musical performance given by a performer, the musical performance recording device including: a first storage unit configured to store musical performance data indicating a musical performance and musical performance date/time data relating to a date/time when the musical performance was given in association with each other; a second storage unit configured to store image data indicating an image and image date/time data indicating a date/time relating to pickup or recording of the image using the image pickup device in association with each other; and a transmission unit configured to identify the image date/time data associated with a piece of image data selected by the user from among pieces of image data stored in the second storage unit, and transmit the musical performance data associated with the musical performance date/time data having a predetermined relationship with the identified image date/time data in the first storage unit to a musical performance device.

Further, according to another aspect of the present invention, there is provided a musical performance system, including: a first acquisition unit configured to acquire a plurality of pieces of musical performance data each indicating a musical performance and a plurality of pieces of musical performance date/time data that are associated with the plurality of pieces of musical performance data on a one-to-one basis and each relating to a date/time when one of a plurality of musical performances was given; a second acquisition unit configured to acquire a plurality of pieces of image data each indicating an image and a plurality of pieces of image date/time data that are associated with the plurality of pieces of image data on a one-to-one basis and each indicating a date/time relating to pickup or recording of one of a plurality of images; an identification unit configured to identify one piece of musical performance data from among the plurality of pieces of musical performance data based on the image date/time data associated with the image data selected by a user from among the plurality of pieces of image data and the plurality of pieces of musical performance date/time data; and a transmission unit configured to transmit the identified one piece of musical performance data.

Further, according to another aspect of the present invention, there is provided a musical performance method, including: acquiring a plurality of pieces of musical performance data each indicating a musical performance and a plurality of pieces of musical performance date/time data that are associated with the plurality of pieces of musical performance data on a one-to-one basis and each relating to a date/time when one of a plurality of musical performances was given; acquiring a plurality of pieces of image data each indicating an image and a plurality of pieces of image date/time data that are associated with the plurality of pieces of image data on a one-to-one basis and each indicating a date/time relating to pickup or recording of one of a plurality of images; identifying one piece of musical performance data from among the plurality of pieces of musical performance data based on the image date/time data associated with the image data selected by a user from among the plurality of pieces of image data and the plurality of pieces of musical performance date/time data; and transmitting the identified one piece of musical performance data.

Further, according to another aspect of the present invention, there is provided a musical performance program, including the instructions to: acquire a plurality of pieces of musical performance data each indicating a musical performance and a plurality of pieces of musical performance date/time data that are associated with the plurality of pieces of musical performance data on a one-to-one basis and each relating to a date/time when one of a plurality of musical performances was given; acquire a plurality of pieces of image data each indicating an image and a plurality of pieces of image date/time data that are associated with the plurality of pieces of image data on a one-to-one basis and each indicating a date/time relating to pickup or recording of one of a plurality of images; identify one piece of musical performance data from among the plurality of pieces of musical performance data based on the image date/time data associated with the image data selected by a user from among the plurality of pieces of image data and the plurality of pieces of musical performance date/time data; and transmit the identified one piece of musical performance data.

### Advantageous Effects of Invention

According to one or more embodiments of the present invention, the user is enabled to visually identify the musical performance data to be reproduced with ease.

### BRIEF DESCRIPTION OF DRAWINGS

FIG. 1 is a diagram for illustrating an overall configuration of a musical performance recording/reproducing system 1 according to an embodiment of the present invention.

FIG. 2 is a diagram for illustrating a hardware configuration of a musical performance device.

FIG. 3 is a diagram for illustrating a hardware configuration of an image pickup device.

FIG. 4 is a diagram for illustrating a hardware configuration of an image recording server device.

FIG. 5 is a diagram for illustrating an example of image information.

FIG. 6 is a diagram for illustrating a hardware configuration of a musical performance recording server device.

FIG. 7 is a diagram for illustrating an example of musical performance information.

FIG. 8 is a sequence diagram for illustrating an operation of an entire system conducted when a musical performance is recorded.

FIG. 9 is a sequence diagram for illustrating an operation of the entire system conducted when the musical performance is reproduced.

FIG. 10 is a diagram for illustrating an example of a case where the image data is displayed on the image pickup device at a time of reproduction of the musical performance.

FIG. 11 is a diagram for illustrating another example of the case where the image data is displayed on the image pickup device at the time of reproduction of the musical performance.

FIG. 12 is a diagram for illustrating another example of the case where the image data is displayed on the image pickup device at the time of reproduction of the musical performance.

FIG. 13 is a diagram for illustrating another example of the case where the image data is displayed on the image pickup device at the time of reproduction of the musical performance.

FIG. 14 is a diagram for illustrating another example of the case where the image data is displayed on the image pickup device at the time of reproduction of the musical performance.

FIG. 15 is a diagram for illustrating another example of the case where the image data is displayed on the image pickup device at the time of reproduction of the musical performance.

### DESCRIPTION OF EMBODIMENTS

### Embodiment

### Overall Configuration of Musical Performance Recording/Reproducing System 1

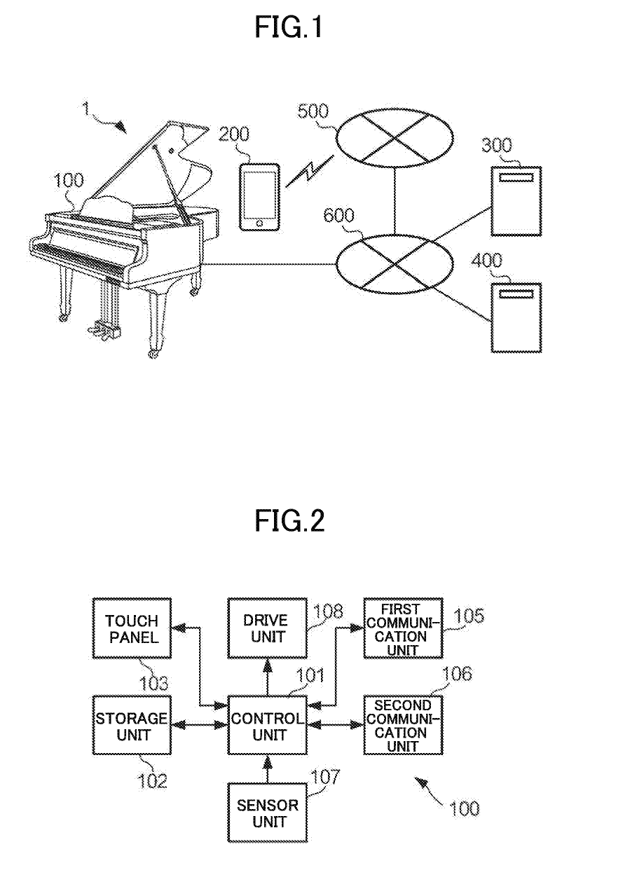

FIG. 1 is a diagram for illustrating an overall configuration of a musical performance recording/reproducing system 1 according to an embodiment of the present invention. The musical performance recording/reproducing system 1 includes a musical performance device 100, an image pickup device 200, an image recording server device 300, a musical performance recording server device 400, a mobile communication network 500, and an Internet 600. The image recording server device 300 and the musical performance recording server device 400 form a musical performance recording device according to one or more embodiments of the present invention. In this musical performance recording/reproducing system 1, when a performer gives a musical performance by using the musical performance device 100, the image pickup device 200 picks up an image of a scene of the musical performance. At that time, musical performance data indicating the musical performance is recorded onto the musical performance recording server device 400 along with a musical performance date/time. Further, image data indicating the image is recorded onto the image recording server device 300 along with an image pickup date/time of that time. To reproduce the musical performance, a user visually selects the image picked up at a time of a desired musical performance from among the images recorded on the image recording server device 300. Then, the musical performance data associated with the musical performance date/time close to the image pickup date/time of the selected image is identified on the musical performance recording server device 400, and the musical performance is reproduced on the musical performance device 100 based on the musical performance data. Note that, the numbers of musical performance devices 100, image pickup devices 200, image recording server devices 300, and musical performance recording server devices 400 that are included in the musical performance recording/reproducing system 1 may be more than one, but are each only one in the illustration of FIG. 1 in order to prevent the illustration from being complicated.

The musical performance device 100 is a device configured to give a musical performance based on the user's operation. In this embodiment, the musical performance device 100 is an acoustic piano having an automatic musical performance function of giving the musical performance based on the musical performance data. The image pickup device 200 is a device configured to pick up an image. In this embodiment, the image pickup device 200 is a portable image pickup device such as a mobile phone, a smartphone, or a tablet PC. The image pickup device 200 has a first communication function of exchanging information with the musical performance device 100 and a second communication function of communicating to/from the image recording server device 300 and the musical performance recording server device 400 through the mobile communication network 500 and the Internet 600 (hereinafter referred to as “communication network”). Note that, the image pickup device 200 may communicate to/from the image recording server device 300 and the musical performance recording server device 400 through only the Internet 600 without the intermediation of the mobile communication network 500. The image recording server device 300 has a function of storing data received from the image pickup device 200 through the communication network, and transmitting the stored data in response to a request issued from the image pickup device 200. The musical performance recording server device 400 has a function of storing data received from the musical performance device 100 through the communication network, and transmitting the stored data in response to a request issued from the musical performance device 100 or the image pickup device 200.

### Configuration of Musical Performance Device 100

The musical performance device 100 includes not only the same mechanism as a mechanism provided to a general acoustic piano, such as an action mechanism for striking a string in synchronization with a motion of a key of a keyboard and a damper for stopping a vibration of the string, but also an electrical hardware configuration as illustrated in FIG. 2. A storage unit 102 is, for example, a nonvolatile storage unit such as a hard disk drive, and stores a musical performance device ID for uniquely identifying the musical performance device 100 and various kinds of information and a file that are generated by the control unit 101. A first communication unit 105 communicates to/from a first communication unit 208 of the image pickup device 200 in accordance with, for example, a wireless communication standard such as infrared or

Bluetooth (trademark) or a predetermined wired communication standard (for example, LAN). A second communication unit 106 communicates to/from the image recording server device 300 or the musical performance recording server device 400 through the communication network via, for example, a LAN. A touch panel 103 is a user interface configured to display a screen or the like for operating the musical performance device 100 to receive an operation from the user. Note that, the user interface may be configured by a display and an operation unit instead of the touch panel 103.

A sensor unit 107 includes a sensor configured to detect the motion of the key of the keyboard. The sensor is provided to each key, and when the performer operates the key to give a musical performance, a signal corresponding to the motion of the key is output from the sensor unit 107 to the control unit 101. A drive unit 108 includes an actuator (for example, solenoid) configured to drive the key of the keyboard. The actuator is provided to each key of the keyboard. When the actuator is driven based on Musical Instrument Digital Interface (MIDI; trademark) data, the key is put into motion, and the action mechanism operates in synchronization with the motion of the key, to thereby cause string striking.

The control unit 101 is a microcontroller including a central processing unit (CPU), a read only memory (ROM), and a random access memory (RAM). The CPU executes a program stored in the ROM to implement the function of generating the MIDI data based on an operation of the keyboard, an automatic musical performance function of giving a musical performance based on the MIDI data, and a timing function of measuring a date/time.

### Configuration of Image Pickup Device 200

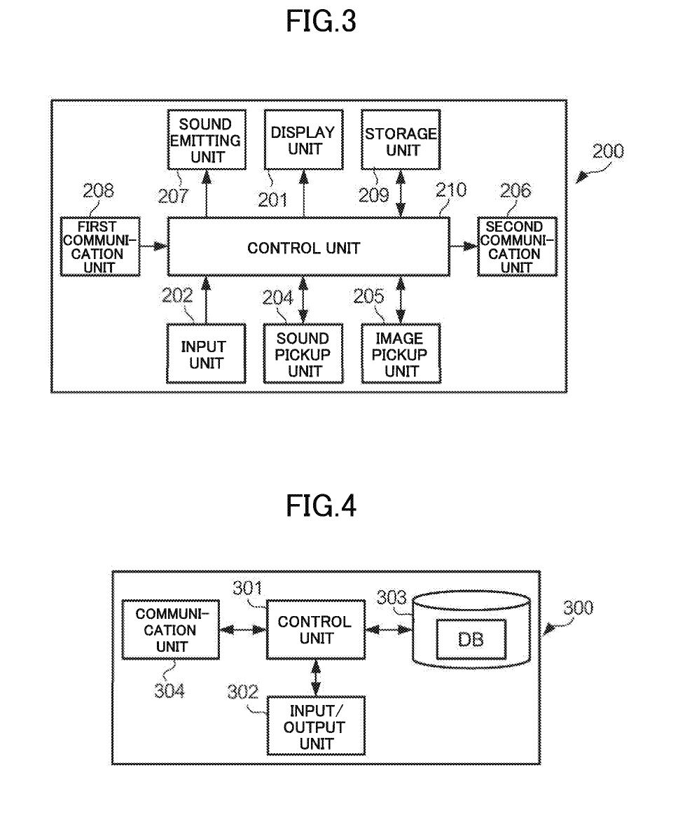

FIG. 3 is a diagram for illustrating a hardware configuration of the image pickup device 200. The image pickup device 200 includes a display unit 201, an input unit 202, a sound pickup unit 204, an image pickup unit 205, a second communication unit 206, a sound emitting unit 207, the first communication unit 208, a storage unit 209, and a control unit 210. The display unit 201 is a display device such as a liquid crystal display. The input unit 202 is implemented by a numeric keypad or a touch panel, and receives the user's operation. The sound pickup unit 204 is formed of a microphone and a sound processing circuit, and picks up sound. The image pickup unit 205 is formed of a lens, an image sensor, and a video signal processing circuit, and picks up an image. The second communication unit 206 is implemented by an antenna and a radio signal processing circuit, and communicates to/from the image recording server device 300 and the musical performance recording server device 400 through the communication network in accordance with a wireless communication standard such as so-called 3G, Long TermEvolution (LTE) , or a wireless local area network (LAN). The first communication unit 208 communicates to/from the first communication unit 105 of the musical performance device 100 in accordance with, for example, a wireless communication standard such as infrared or Bluetooth (trademark) or a predetermined wired communication standard (for example, LAN). The sound emitting unit 207 is a speaker, and is used for voice communications and also used to inform the user of various kinds of information by voice. The storage unit 209 is, for example, a storage unit such as an electronically erasable and programmable ROM (EEPROM) or a flash memory, and stores programs to be executed by the control unit 210. Those programs may be provided to and stored in the storage unit 209 by using a storage medium or by being downloaded through the Internet or the like. The control unit 210 is a microcontroller including a CPU, a ROM, and a RAM, and controls operations of the respective units of the image pickup device 200. The CPU executes the program stored in the ROM to implement, for example, a timing function of measuring a date/time.

### Configuration of Image Recording Server Device 300

FIG. 4 is a block diagram for illustrating a hardware configuration of the image recording server device 300. The image recording server device 300 is a computer including a control unit 301, an input/output unit 302, a storage unit 303, and a communication unit 304. The control unit 301 includes an arithmetic unit such as a CPU and a storage device such as a ROM or a RAM. The CPU executes programs stored in the ROM and the storage unit 303 by using the RAM as a work area, to thereby control operations of the respective units of the image recording server device 300. The input/output unit 302 includes an input device such as a keyboard and a mouse and a display device. The communication unit 304 is connected to the communication network, and conducts communications through the communication network. The storage unit 303 is, for example, a nonvolatile, large-capacity storage unit such as a hard disk drive. The storage unit 303 stores a data group and a program group to be used by the control unit 301, and for example, stores an image database. The storage unit 303 functions as a second storage unit configured to store the image data indicating the image, image date/time data indicating a date/time relating to pickup or recording of the image, the musical performance device ID being identification information for identifying the musical performance device 100, and a service identification tag being tag information for identifying that the data is to be subjected to a service provided by the musical performance recording/reproducing system 1, in association with one another.

FIG. 5 is a diagram for illustrating an example of the image database. In the image database, the image date/time data, the musical performance device ID, the image data, and the service identification tag are associated with one another. The image data is data indicating an image obtained when a scene in which the performer was giving a musical performance by using the musical performance device 100 was picked up by the image pickup device 200. The image date/time data is data indicating the date/time relating to the pickup or recording of the image, and in this case, is data indicating the date/time when the image was picked up. The musical performance device ID is the identification information for identifying the musical performance device 100. The service identification tag is the tag information for identifying that the data is to be subjected to the service provided by the musical performance recording/reproducing system 1.

### Configuration of Musical Performance Recording Server Device 400

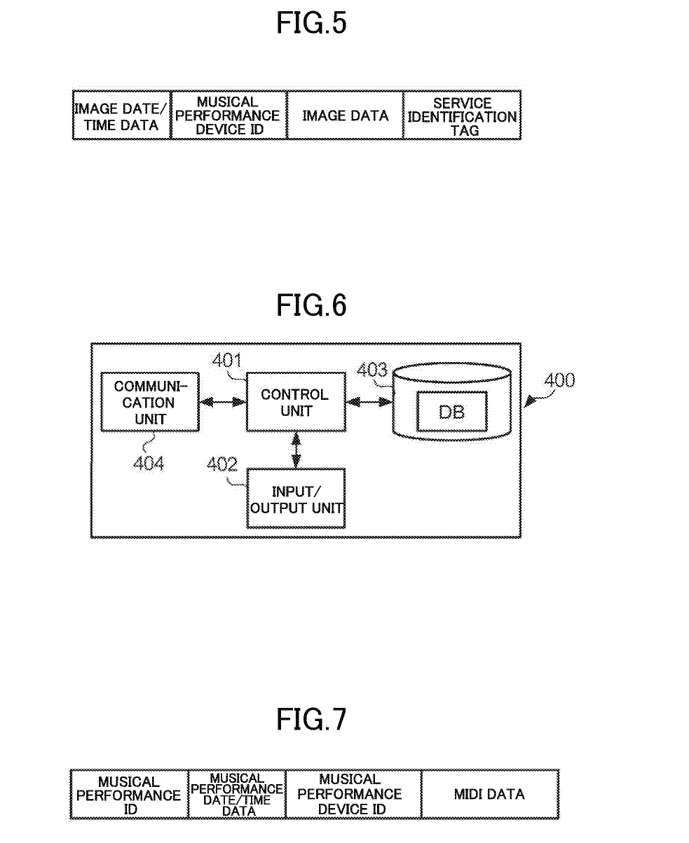

FIG. 6 is a block diagram for illustrating a hardware configuration of the musical performance recording server device 400. As in the image recording server device 300, the musical performance recording server device 400 is a computer including a control unit 401, an input/output unit 402, a storage unit 403, and a communication unit 404. The control unit 401 includes an arithmetic unit such as a CPU and a storage device such as a ROM or a RAM. The CPU executes programs stored in the ROM and the storage unit 403 by using the RAM as a work area, to thereby control operations of the respective units of the musical performance recording server device 400. The input/output unit 402 includes an input device such as a keyboard and a mouse and a display device. The communication unit 404 is connected to the communication network, and conducts communications through the communication network. The storage unit 403 is, for example, a nonvolatile, large-capacity storage unit such as a hard disk drive. The storage unit 403 stores a data group and a program group to be used by the control unit 401, and for example, stores a musical performance database. The storage unit 403 functions as a first storage unit configured to store the musical performance data indicating the musical performance and musical performance date/time data relating to the date/time when the musical performance was given, in association with each other.

FIG. 7 is a diagram for illustrating an example of the musical performance database. In the musical performance database, a musical performance ID, the musical performance date/time data, the musical performance device ID, and MIDI data are associated with one another. The musical performance ID is an identifier for identifying an individual musical performance. The MIDI data is the musical performance data indicating the musical performance given on the musical performance device 100. The musical performance date/time data is data relating to the date/time when the musical performance was given, and in this case, is data indicating the date/time when the recording of the musical performance was started. The musical performance device ID is a musical performance device ID for identifying the musical performance device 100.

The control unit 301 of the image recording server device 300 and the control unit 401 of the musical performance recording server device 400 function as a transmission unit configured to identify the image date/time data associated with a piece of image data selected by the user from among pieces of image data stored in the storage unit 303 (second storage unit) of the image recording server device 300, and transmitting the musical performance data (MIDI data) associated with the musical performance date/time data having a predetermined relationship with the identified image date/time data in the storage unit 403 (first storage unit) of the musical performance recording server device 400 to the musical performance device 100.

### Operation for Recording Musical Performance

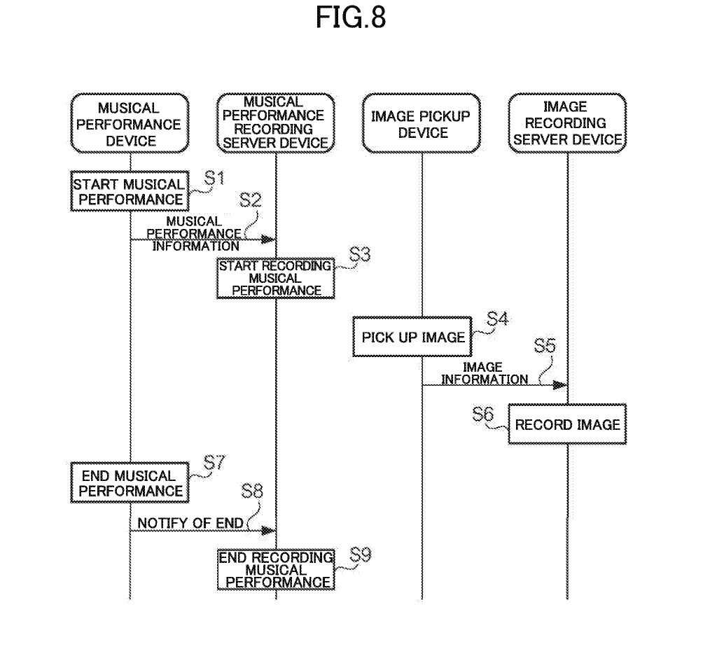

FIG. 8 is a sequence diagram for illustrating an operation of an entire system conducted when a musical performance is recorded. First, when the performer starts a musical performance using the musical performance device 100 (Step S1), the control unit 101 of the musical performance device 100 transmits musical performance information to the musical performance recording server device 400. The musical performance information includes the MIDI data generated based on a result of the musical performance, date/time information indicating the date/time when the musical performance was started, and the musical performance device ID of the musical performance device 100 (Step S2). The control unit 401 of the musical performance recording server device 400 assigns a new musical performance ID to those pieces of musical performance information, and starts recording the musical performance into the storage unit 403 (Step S3).

On the other hand, a third party who is listening to the musical performance given by the performer (or the performer himself/herself) uses the image pickup device 200 to pick up an image of the scene of the musical performance given by the performer (Step S4). The control unit 210 of the image pickup device 200 transmits image information to the image recording server device 300. The image information includes the image data indicating the image that was picked up, the date/time information indicating the date/time when the image was picked up, the musical performance device ID of the musical performance device 100, and the service identification tag (Step S5). The musical performance device ID may be input to the image pickup device 200 by the user, or may be preset in the image pickup device 200 to be stored into the storage unit 209. The control unit 301 of the image recording server device 300 records the image information into the storage unit 303 (Step S6). Note that, before Step S5, the musical performance device 100 may transmit the musical performance device ID to the image pickup device 200 through the first communication function, and the image pickup device 200 may store the musical performance device ID into the storage unit 209.

When the performer ends the musical performance using the musical performance device 100 (Step S7), the control unit 101 of the musical performance device 100 notifies the musical performance recording server device 400 that the musical performance has been ended (Step S8). In response to this notification, the control unit 401 of the musical performance recording server device 400 ends recording the musical performance information into the storage unit 403 (Step S9).

### Operation for Reproducing Musical Performance

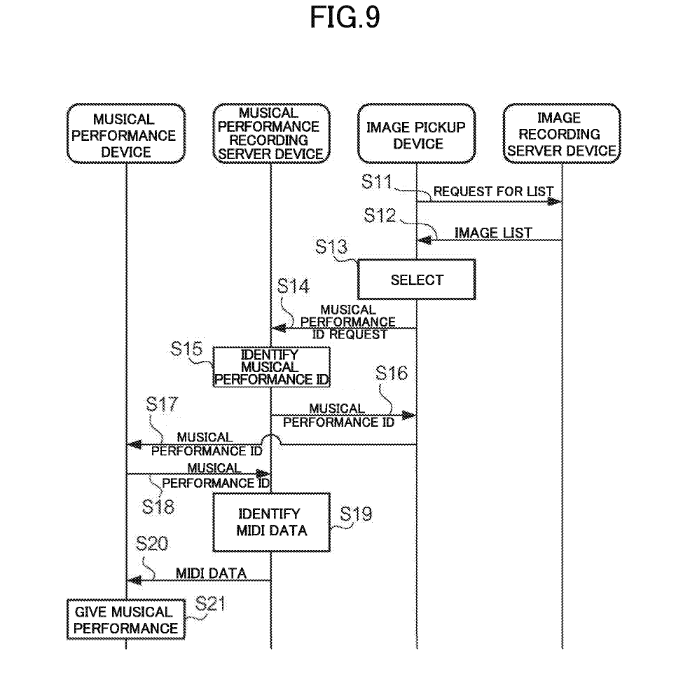

FIG. 9 is a sequence diagram for illustrating an operation of the entire system conducted when the musical performance is reproduced. First, when the user conducts a predetermined operation on the image pickup device 200, the control unit 210 of the image pickup device 200 requests the image recording server device 300 for a list of the recorded pieces of image data (Step S11). This request includes the service identification tag. In response to this request, the control unit 301 of the image recording server device 300 generates an image list obtained by converting pieces of image data associated with the above-mentioned service identification tag into thumbnails, and transmits the image list to the image pickup device 200 (Step S12). This image list includes the respective pieces of image data, and also includes pieces of date/time data and the musical performance device IDs associated with the respective pieces of image data. Note that, the request for this image list may include not only the service identification tag but also the musical performance device ID. In that case, in response to this request, the control unit 301 of the image recording server device 300 generates the image list obtained by converting the pieces of image data associated with the service identification tag and the musical performance device ID that are described above into thumbnails, and transmits the image list to the image pickup device 200.

When this image list is displayed on the image pickup device 200, the user visually recognizes the images each indicating the scene of the musical performance, and selects the image assumed to have been picked up at a time of a desired musical performance from among the recognized images (Step S13). In response to this selection operation, the control unit 210 transmits a musical performance ID request including the date/time data and the musical performance device ID corresponding to the selected piece of image data to the musical performance recording server device 400 (Step S14). The control unit 401 of the musical performance recording server device 400 identifies the musical performance ID within a piece of musical performance information including the musical performance date/time data having a predetermined relationship with the above-mentioned image date/time data among pieces of musical performance information having the same musical performance device ID as the received musical performance device ID (Step S15). In this case, the musical performance ID within a piece of musical performance information including the musical performance date/time data indicating a date/time close to the date/time indicated by the image date/time data, more specifically, the musical performance date/time data having a difference from the image date/time data within a threshold value (for example, 5 minutes), is identified. The control unit 401 transmits the musical performance ID to the image pickup device 200 (Step S16). The control unit 210 of the image pickup device 200 transmits the received musical performance ID to the musical performance device 100 (Step S17). The control unit 101 of the musical performance device 100 transmits the received musical performance ID to the musical performance recording server device 400 (Step S18). The control unit 401 of the musical performance recording server device 400 identifies the MIDI data corresponding to the received musical performance ID (Step S19), and transmits the MIDI data to the musical performance device 100 (Step S20). The control unit 101 of the musical performance device 100 gives an automatic musical performance based on the received MIDI data (Step S21).

According to the above-mentioned embodiment, when the performer gives a musical performance by using the musical performance device 100, the image pickup device 200 picks up an image of the scene of the musical performance. At that time, the musical performance data indicating the musical performance is recorded onto the musical performance recording server device 400 along with the musical performance date/time. Further, the image data indicating the image is recorded onto the image recording server device 300 along with the image pickup date/time of that time. To reproduce the musical performance, the user visually selects the image picked up at the time of the desired musical performance from among the images recorded on the image recording server device 300.

The musical performance data associated with the musical performance date/time close to the image pickup date/time of the selected image is identified on the musical performance recording server device 400, and the musical performance is reproduced on the musical performance device 100 based on the musical performance data.

Accordingly, the user can visually identify the musical performance data to be reproduced with ease.

### Modification Example

The present invention may be carried out by modifying the above-mentioned embodiment as follows. Note that, the above-mentioned embodiment and the following modification example may be combined with each other.

In the above-mentioned embodiment, the musical performance device 100 is an automatic musical performance piano including the mechanism of the acoustic piano, but the musical performance device 100 is not limited to this automatic musical performance piano. For example, the musical performance device 100 may be an electronic piano or an electronic keyboard that does not include the mechanism of the acoustic piano. Further, the musical performance device 100 is not limited to a keyed instrument, and may be any other musical performance device that can output the MIDI data based on the musical performance given by the performer.

In the above-mentioned embodiment, the MIDI data is stored as the musical performance data, but the present invention is not limited to the MIDI data. For example, audio data obtained by converting the MIDI data may be stored, or sound of the musical performance may be picked up with a microphone and digitized to be stored.

It suffices that the musical performance date/time data is the musical performance date/time data relating to the date/time when the musical performance was given. In the embodiment, the musical performance date/time data indicates a date and a time, but the present invention is not limited to this configuration, and the musical performance date/time data may indicate only a date or only a time. Further, instead of the date/time when the recording of the musical performance was started, the musical performance date/time data may indicate a date/time when the recording of the musical performance was ended, a date/time during a period of the recording of the musical performance, or a date/time before or after the recording of the musical performance. In short, the musical performance date/time data may indicate any date/time that allows identification of the musical performance.

It suffices that the image date/time data is the image date/time data indicating the date/time relating to the pickup or recording of the image. In the embodiment, the image date/time data indicates a date and a time, but the present invention is not limited to this configuration, and the image date/time data may indicate only a date or only a time. Further, instead of the date/time when the image was picked up during a period of the musical performance, the image date/time data may indicate a date/time when the image was picked up before the musical performance was started or after the musical performance was ended. Further, instead of a timing of the image pickup, the image date/time data may indicate a date/time when the image was recorded onto the image recording server device 300. In short, the image date/time data may indicate such a date/time as to allow identification of a correspondence between the image data and the musical performance data based on the musical performance date/time data and the image date/time data.

Further, not only one piece of image data but also a plurality of pieces of image data may be obtained for one musical performance. Further, the image may be a still image or a moving image. Further, the image data is not limited to the image data on the picked-up image, but may be image data downloaded or obtained through any other method by the user.

The image pickup device 200 may pick up an image of a piece of sheet music, and the image recording server device 300 may perform pattern matching between the picked-up image of the piece of sheet music and images of pieces of sheet music that are read by a scanner and stored in advance, and include, in the musical performance information, the image information on a piece of sheet music determined to be the same as or similar to the picked-up image of the piece of sheet music among the images stored in advance. Further, a music title of the piece of sheet music determined by the pattern matching to be the same as or similar to the picked-up image of the piece of sheet music maybe identified, and information indicating the identified music title may be included in the musical performance information. Note that, instead of the picked-up image of the piece of sheet music, a picked-up image of a character string (for example, character string of a music title described in a book) may be used to identify a music title by recognizing text therefrom through a known character recognition technology. Further, in a case where the musical performance data included in this musical performance information is to be reproduced, the music title included in the musical performance information may be displayed on the touch panel 103. In addition, the text recognized through the character recognition technology may be displayed on the touch panel 103 along with the picked-up image.

Further, information other than the information described in the embodiment, for example, voice of the user may be included in the image information or the musical performance information to be stored.

In the embodiment, the image recording server device 300 and the musical performance recording server device 400 are provided as separate devices, but may be integrated into one musical performance recording device. In this case, when the user visually recognizes the images each indicating the scene of the musical performance and selects the image assumed to have been picked up at the time of the desired musical performance from among the recognized images, the musical performance ID request including the date/time data and the musical performance device ID that correspond to the selected image data is transmitted to the musical performance recording device. At this time, the musical performance recording device identifies the musical performance ID within the piece of musical performance information including the musical performance date/time data having a predetermined relationship with the above-mentioned image date/time data among the pieces of musical performance information having the same musical performance device ID as the received musical performance device ID. In addition, the musical performance recording device can identify the MIDI data corresponding to this musical performance ID, and may therefore transmit the MIDI data to the musical performance device 100. In other words, one musical performance recording device implements the transmission unit configured to identify the image date/time data associated with the piece of image data selected by the user from the among pieces of image data stored in the storage unit 303 (second storage unit) of the image recording server device 300, and transmitting, to the musical performance device 100, the musical performance data (MIDI data) associated with the musical performance date/time data having a predetermined relationship with the identified image date/time data in the storage unit 403 (first storage unit) of the musical performance recording server device 400.

The “predetermined relationship” as used to identify the musical performance date/time data having a predetermined relationship with the image date/time data is not limited to the case of having a difference from the date/time within the threshold value as exemplified in the embodiment, and may be, in short, such a relationship as to allow identification of the correspondence between the image data and the musical performance data based on the musical performance date/time data and the image date/time data. Specifically, for example, when the image date/time data indicates a date/time between a musical performance start date/time and a musical performance end date/time of the musical performance data, the system may be configured to identify the musical performance data as the musical performance data having a predetermined relationship with the image date/time data. On the other hand, when the image date/time data does not indicate a date/time between the musical performance start date/time and the musical performance end date/time of the musical performance data, the system may be configured to compare between the musical performance data having a musical performance start date/time after the date/time indicated by the image date/time data and the musical performance data having a musical performance end date/time before the date/time indicated by the image date/time data, and identify the musical performance data closer to the date/time indicated by the image date/time data as the musical performance data having a predetermined relationship with the image date/time data.

Further, in Step S5, when the musical performance device 100 and the image pickup device 200 hold positional information, the image pickup device 200 may include the musical performance device ID of the musical performance device 100 closest to the image pickup device 200 in the image information without depending on the user's input, to transmit the musical information to the image recording server device 300.

Further, in response to the selection operation of Step S13, the control unit 210 may request the image recording server device 300 to transmit the image data including the musical performance device ID corresponding to the selected image data to the image pickup device 200. After that, the control unit 210 may implement a slideshow function by displaying a plurality of received pieces of image data on the display unit 201 in chronological order of the date/time information, with the oldest first, each for a predetermined time period.

Further, the embodiment is described above mainly by taking a case where the musical performance device 100 is configured to give an automatic musical performance based on the user's selection of the image data, but a terminal such as the image pickup device 200 may be configured to reproduce the musical performance data. Specifically, for example, the musical performance recording server 400 transmits the musical performance data identified based on the user's selection of the image data to the image pickup device 200, and the image pickup device 200 reproduces the musical performance data.

Further, in this case, the terminal such as the image pickup device 200 may be configured to display the image data relating to the musical performance data while reproducing the musical performance data. In this case, for example, the musical performance recording server device 400 identifies at least one piece of image data from among the plurality of pieces of image data based on the musical performance date/time data associated with the identified musical performance data, and transmits the at least one piece of image data to the image pickup device 200 along with the image date/time data associated with the at least one piece of image data. Then, the image pickup device 200 displays the at least one piece of image data when reproducing the musical performance data.

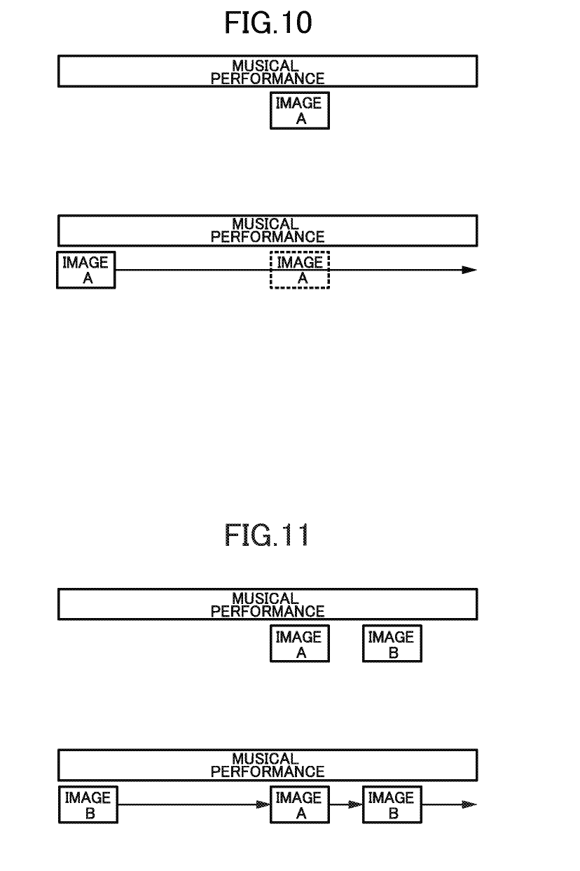

More specifically, for example, the system may be configured to display, when a piece of image data (Image A) indicating the image date/time data indicating a date/time between the musical performance start date/time and the musical performance end date/time of a given piece of musical performance data is selected as illustrated in the top of FIG. 10, the piece of image data from a start time of the musical performance of the given piece of musical performance data to an end time of the musical performance as illustrated in the bottom of FIG. 10. Note that, temporal locations of the musical performance data and the image data are illustrated in the top of FIG. 10, and temporal locations, in terms of display, of the musical performance data and the image data being displayed are illustrated in the bottom of FIG. 10. In other words, in FIG. 10, a movement along a direction from the left to the right corresponds to a lapse of time. Note that, a relationship between the top and the bottom of FIG. 10 is the same as that of FIG. 11 to FIG. 15 described below.

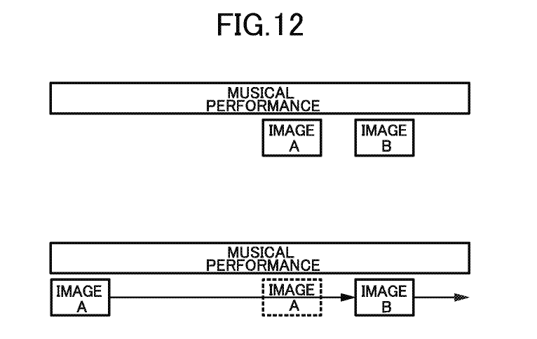

Further, in a case where, as illustrated in the top of FIG. 11, there exist a plurality of pieces of image data (Images A and B) indicating the image date/time data indicating a date/time between the musical performance start date/time and the musical performance end date/time of a given piece of musical performance data, the system may be configured to display, when one piece of image data (Image B) is selected, as illustrated in the bottom of FIG. 11, the selected Image B from a musical performance start time of the musical performance data, and display another piece of image data (Image A) after a time period since the musical performance start time of the musical performance data has elapsed by a time period corresponding to a difference between a date/time indicated by the image date/time data of the another piece of image data (Image A) and the time indicated by the musical performance start date/time of the musical performance data. Further, the system may be configured to display the one piece of image data (Image B) after the time period since the musical performance start time of the musical performance data has elapsed by a time period corresponding to a difference between a date/time indicated by the image date/time data of the one piece of image data (Image B) and the time indicated by the musical performance start date/time of the musical performance data. Note that, the system may be configured to continuously display the one piece of image data and the another piece of image data until the next image is displayed while the musical performance data is being reproduced. Note that, in this case, as illustrated in the top of FIG. 12 and the bottom of FIG. 12, when the date/time indicated by the image date/time data of the selected piece of image data (Image A) is the closest to the musical performance start date/time, the image data (Image A) is already displayed at a timing to display the image data (Image A), and hence the image data (Image A) is continuously displayed until another piece of image data is displayed. Note that, the timing to display Image A is the same as described above, and hence a description thereof is omitted. Further, when a plurality of videos are switched to be displayed as described above, a time lag can occur when the video is, for example, faded out or flipped. Therefore, it should be understood that a timing to switch the display in a strict sense is not necessarily required.

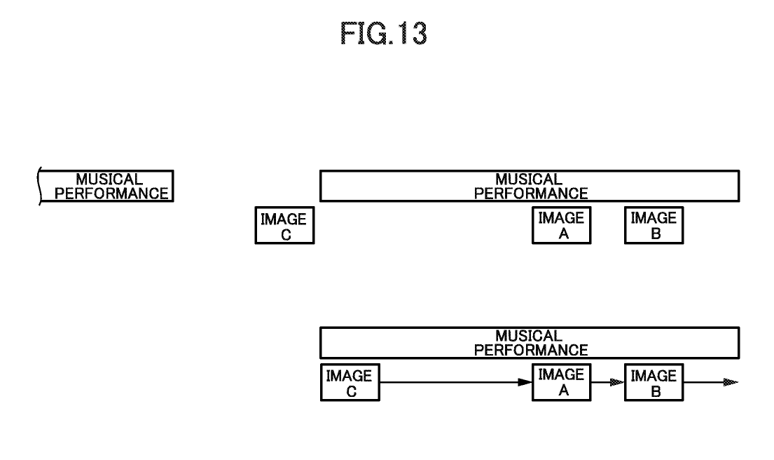

Further, for example, in a case where, as illustrated in the top of FIG. 13, there exist pieces of image data (Images A and B) indicating the image date/time data indicating a date/time between the musical performance start date/time and the musical performance end date/time of a given piece of musical performance data, and where there further exists another piece of image data (Image C) before the musical performance start date/time of the given piece musical performance data or after the musical performance end date/time of the given piece musical performance data in a position temporally closer than any other pieces of musical performance data, the system may be configured to display Image C when Image C is selected as illustrated in the lower side of FIG. 13, and then display Image A and Image B at the timings to display Image A and Image B, respectively. Note that, the timings to display Images A and B are the same as described above, and hence descriptions thereof are omitted.

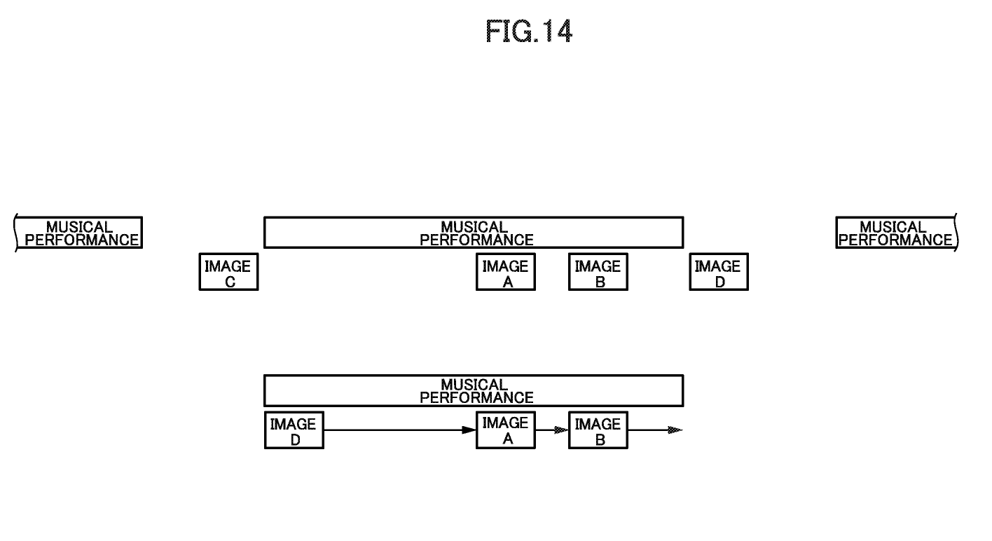

Further, for example, in a case where, as illustrated in the top of FIG. 14, there exist pieces of image data (Images A and B) indicating the image date/time data indicating a date/time between the musical performance start date/time and the musical performance end date/time of a given piece of musical performance data, and where there further exist other pieces of image data (Images C and D) in positions temporally closer to the musical performance start date/time and the musical performance end date/time of the given piece musical performance data than any other pieces of musical performance data, the system may be configured to display Image D when Image D is selected as illustrated in the lower side of FIG. 14B, and then display Image A and Image B at the timings to display Image A and Image B, respectively. Note that, the timings to display Images A and B are the same as described above, and hence descriptions thereof are omitted.

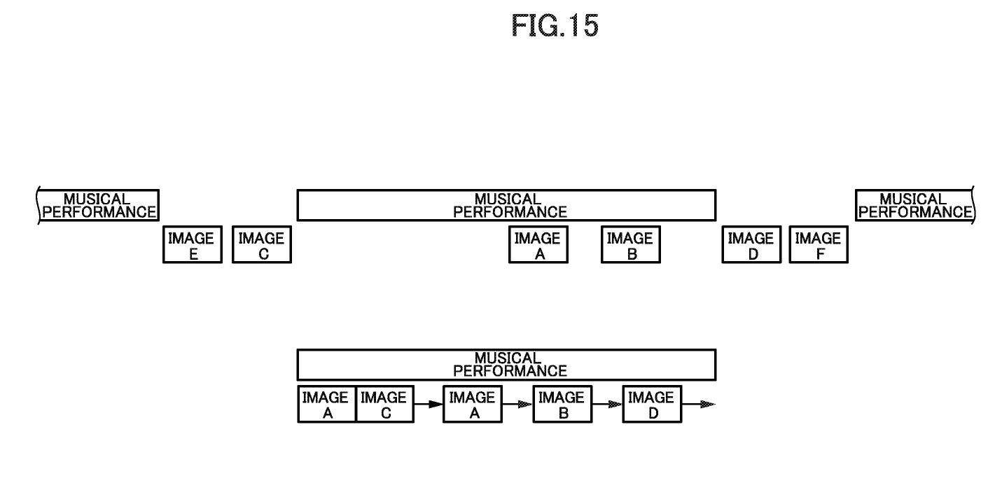

Further, for example, in a case where, as illustrated in the top of FIG. 15, there exist pieces of image data (Images A and B) indicating the image date/time data indicating a date/time between the musical performance start date/time and the musical performance end date/time of a given piece of musical performance data, and where there further exist other pieces of image data (Images C and D) in positions temporally closer to the musical performance start date/time and the musical performance end date/time of the given piece musical performance data than any other pieces of musical performance data, the system may be configured to display those pieces of image data (Images A to D) temporally at substantially regular intervals as illustrated in the bottom of FIG. 15 irrespective of which of the pieces of image data is selected. Note that, an order set in this case may be, for example, an order based on the date/time indicated by the image date/time data of the image data. In addition, in this case, the system may be configured to display the selected image data as the image data displayed at the musical performance start time of the musical performance data or during a musical performance standby of the musical performance data. Note that, a case where the selected image data is Image A is illustrated in the bottom of FIG. 15. Note that, the system may be configured to display the selected image data during the musical performance standby also in the cases described with reference to FIG. 11 to FIG. 14. Further, it should be understood that the examples illustrated in FIG. 10 to FIG. 15 may be combined to be used unless a contradiction occurs between the examples to be combined.

The present invention may also be carried out in a form of an information processing method conducted by each device or a program for causing a computer to function as each device. Such a program can be provided in a form recorded on a recording medium such as an optical disc, or can be provided in, for example, such a form as to be available by being downloaded and installed onto the computer through the network such as the Internet. Note that, the musical performance data within the appended claims includes not only the musical performance data for music but also other data relating to sound such as speech data indicating voice.

1. A musical performance system, comprising:
a first acquisition unit configured to acquire a plurality of pieces of musical performance data and a plurality of pieces of musical performance date/time data that are associated with the plurality of pieces of musical performance data on a one-to-one basis and each relating to a date/time when one of a plurality of musical performances was given;
a second acquisition unit configured to acquire a plurality of pieces of image data each indicating an image and a plurality of pieces of image date/time data that are associated with the plurality of pieces of image data on a one-to-one basis and each indicating a date/time relating to pickup or recording of one of a plurality of images;
an identification unit configured to identify one piece of musical performance data from among the plurality of pieces of musical performance data based on the image date/time data associated with the image data selected by a user from among the plurality of pieces of image data and the plurality of pieces of musical performance date/time data; and
a transmission unit configured to transmit the identified one piece of musical performance data.

2. The musical performance system according to claim 1, further comprising a musical performance device comprising a musical performance unit configured to give a musical performance,
wherein at least one piece of musical performance data among the plurality of pieces of musical performance data is generated based on the musical performance given by the musical performance unit.

3. The musical performance system according to claim 2, wherein the musical performance unit is further configured to give the musical performance based on the transmitted one piece of musical performance data.

4. The musical performance system according to claim 1, further comprising an image pickup device comprising an image pickup unit and an image data generating unit configured to generate image data in response to image pickup by the image pickup unit,
wherein the generated image data is included in at least one piece of image data among the plurality of pieces of image data.

5. The musical performance system according to claim 4, wherein the image pickup device further comprises a reproduction unit configured to reproduce the transmitted one piece of musical performance data.

6. The musical performance system according to claim 5, wherein:
the identification unit is further configured to identify at least one piece of image data among the plurality of pieces of image data based on the musical performance date/time data associated with the identified one piece of musical performance data; and
the transmission unit is further configured to transmit the identified at least one piece of image data.

7. The musical performance system according to claim 6, wherein the image pickup device further comprises a display unit configured to display image information corresponding to the identified at least one piece of image data while the transmitted musical performance data is being reproduced.

8. The musical performance system according to claim 7, wherein the display unit is further configured to display, after displaying image information corresponding to the image data selected by the user, the image information corresponding to the at least one piece of image data in an order corresponding to a date/time indicated by the image date/time data associated with the image data.

9. The musical performance system according to claim 8, wherein the display unit is further configured to display the image information corresponding to the image data selected by the user and the image information corresponding to the at least one piece of image data temporally at substantially regular intervals while the transmitted musical performance data is being reproduced.

10. The musical performance system according to claim 1, wherein:
each of the pieces of musical performance date/time data indicates a start date/time of each of the musical performances and an end date/time of the each of the musical performances; and
the identification unit is further configured to identify the musical performance data based on the date/time indicated by the image date/time data associated with the selected image data and the start date/time and the end date/time of the each of the pieces of musical performance date/time data.

11. A musical performance method, comprising:
acquiring a plurality of pieces of musical performance data and a plurality of pieces of musical performance date/time data that are associated with the plurality of pieces of musical performance data on a one-to-one basis and each relating to a date/time when one of a plurality of musical performances was given;
acquiring a plurality of pieces of image data each indicating an image and a plurality of pieces of image date/time data that are associated with the plurality of pieces of image data on a one-to-one basis and each indicating a date/time relating to pickup or recording of one of a plurality of images;
identifying one piece of musical performance data from among the plurality of pieces of musical performance data based on the image date/time data associated with the image data selected by a user from among the plurality of pieces of image data and the plurality of pieces of musical performance date/time data; and
transmitting the identified one piece of musical performance data.

12. A musical performance program, comprising the instructions to:
acquire a plurality of pieces of musical performance data and a plurality of pieces of musical performance date/time data that are associated with the plurality of pieces of musical performance data on a one-to-one basis and each relating to a date/time when one of a plurality of musical performances was given;
acquire a plurality of pieces of image data each indicating an image and a plurality of pieces of image date/time data that are associated with the plurality of pieces of image data on a one-to-one basis and each indicating a date/time relating to pickup or recording of one of a plurality of images;
identify one piece of musical performance data from among the plurality of pieces of musical performance data based on the image date/time data associated with the image data selected by a user from among the plurality of pieces of image data and the plurality of pieces of musical performance date/time data; and
transmit the identified one piece of musical performance data.

13. A computer-readable recording medium having recorded thereon a musical performance program comprising the instructions to:
acquire a plurality of pieces of musical performance data and a plurality of pieces of musical performance date/time data that are associated with the plurality of pieces of musical performance data on a one-to-one basis and each relating to a date/time when one of a plurality of musical performances was given;
acquire a plurality of pieces of image data each indicating an image and a plurality of pieces of image date/time data that are associated with the plurality of pieces of image data on a one-to-one basis and each indicating a date/time relating to pickup or recording of one of a plurality of images;
identify one piece of musical performance data from among the plurality of pieces of musical performance data based on the image date/time data associated with the image data selected by a user from among the plurality of pieces of image data and the plurality of pieces of musical performance date/time data; and
transmit the identified one piece of musical performance data.
